(19) United States
(12) Patent Application Publication
(10) Pub. No.: US 2026/0000068 A1
(43) Pub. Date: Jan. 1, 2026

(54) TERMITE PERIMETER SYSTEM

(71) Applicant: Greenzone Pest Innovations Pty Ltd, Moorabbin (AU)

(72) Inventor: Paul Anthony Commerford, Moorabbin (AU)

(21) Appl. No.: 19/253,002

(22) Filed: Jun. 27, 2025

(30) Foreign Application Priority Data
Jun. 27, 2024 (AU) 2024901972

(51) Int. Cl. A01M 29/34; A01M 1/20

(52) U.S. Cl. CPC A01M 29/34; A01M 1/20

(57) ABSTRACT

A treated mesh sheeting containing an insecticide such that the mesh sheeting acts as a physical and chemical barrier to impede the ingress of insects into a structure, in particular a building structure. The insecticide maybe selected from any one or more of the group comprising pyrethrum, synthetic pyrethroids, organo-chlorines, organo-sulfurs, carbamates, organo-phosphates, formamidines, neonicotinoids, nicotinoids, spinosyns, phenylpyrazoles, pyrroles, pyrazoles, dinitrophenols, pyridazinones, quinazolines, and benzoylureas. The mesh sheeting can be integrally attached to a building structure to impede the ingress of insects, particular termites.

### TECHNICAL FIELD

The present disclosure generally relates to a mesh sheeting for controlling and/or repelling against insects. In particular, the present disclosure relates to a treated mesh sheeting containing an insecticide such that the mesh sheeting acts as a physical and chemical barrier to impede the ingress of insects into a structure.

### BACKGROUND

Buildings and other structures are susceptible to entry by insects. Crawling insects may enter buildings and other structures through gaps between constructions elements. The activity of some insects can have a negative impact on the structural integrity the buildings they have inhabited. For example, termites which feed on timber can cause significant structural damage to buildings.

Physical barriers have been employed to guard against the entry of insects. For example, wire mesh may be installed across the perimeter walls of a building to block hidden entry points from the ground and prevent termite access to the home. Wire mesh is often made of stainless steel and this is an expensive commodity. Reducing the cost of physical barriers would be advantageous.

Chemical barriers may also be employed in an effort to prevent insect ingress into building. For example, liquid pesticides can be sprayed underneath the foundations or around the external perimeter of a building. However, this type of chemical barrier is temporary and needs to be reapplied at regular intervals as the chemicals break down and lose their potency.

There is a need for alternative or improved mesh sheeting, that can provide various desirable properties such as robustness, long life-time, and/or control or repel against insects.

### SUMMARY

The present inventors have surprisingly found that a mesh sheeting containing insecticide may control and/or repel against insects. A mesh sheeting comprising a polymeric material containing at least one insecticide in an effective amount substantially distributed throughout the polymeric material can advantageously act as a physical and chemical barrier to impede the ingress of insects into a building structure.

In one aspect, there is provided a mesh sheeting comprising a polymeric material containing at least one insecticide in an effective amount and substantially distributed throughout the polymeric material, wherein the mesh sheeting is in the form of an open framework, wherein the mesh sheeting has a gauge between about 0.01 mm to about 1 mm and a space cloth between about 1 mm to about 8 mm, and wherein the mesh sheeting acts as a physical and chemical barrier to impede the ingress of insects into a building structure.

In one embodiment, the polymeric material is manufactured from at least one polymer selected from the group comprising polyamide, polyvinylchloride, polyethylene, polystyrene, synthetic rubber, polymethacrylate, polypropylene, EVA polymer, fibreglass, and polyurethane.

In one embodiment, the insecticide exhibits control or repellent affects against insects.

In one embodiment, the insecticide is selected from any one or more of the group comprising pyrethrum, synthetic pyrethroids, organo-chlorines, organo-sulfurs, carbamates, organo-phosphates, formamidines, neonicotinoids, nicotinoids, spinosyns, phenylpyrazoles, pyrroles, pyrazoles, dinitrophenols, pyridazinones, quinazolines, and benzoylureas.

In another aspect, there is provided a termite perimeter system comprising application of the mesh sheeting according to any one of the preceding aspects to a building structure, wherein the mesh sheeting acts as a physical and chemical barrier to impede the ingress of insects into the structure.

In an embodiment, the mesh sheeting is integrally attached to part of the building structure by an adhesive or attachment means providing a bond between at least a portion of the mesh sheeting and part of the building structure.

In another aspect, there is provided a mesh sheeting of any one of the aspects described herein when used in a building structure.

In another aspect, there is provided a method of installing a mesh sheeting according to any one of the preceding aspects comprising: i) providing a mesh sheeting comprising a polymeric material containing at least one insecticide in an effective amount and substantially distributed throughout the polymeric material according to any one of the embodiments described herein; ii) contacting a first portion of the mesh sheeting to a first part of the building structure; and iii) contacting a second portion of the mesh sheeting to a second part of the building structure, wherein, after installation, the mesh sheeting is configured to impede ingress of insects into the building structure between the first part and the second part of the building structure.

In an embodiment, the of the above method the mesh sheeting is integrally attached to the building structure by an adhesive or attachment means providing a bond between the first portion of the mesh sheeting and the first part of the building structure and/or the second portion of the mesh sheeting and the second part of the building structure.

### BRIEF DESCRIPTION OF DRAWINGS

Some embodiments of the present disclosure are described and illustrated herein, by way of example only, with reference to the accompanying Figures in which:

FIG. 1 is an image of the mesh sheeting of one of the embodiments described herein.

FIG. 2 is a schematic of the installed mesh sheeting and an installation method.

FIG. 3 is a schematic of the experimental unit.

FIG. 4 shows steps in the construction of the polymeric experimental units. (A) mesh sheeting rolled around inner PVC pipe and fitted into bottom half of PVC access coupling. (B) Bottom of access coupling showing fitted mesh sheeting and stainless steel mesh of the inner pipe. (C) Placement of Test Wood 1 in experimental unit. (D) Placement of polymeric ant cap barrier and Test Wood 2.

FIG. 5 is a schematic of the experimental set up with the experimental units, in situ. There are a total of seven experimental units in each buried plastic box: one control, three bifenthrin and three deltamethrin, one of each concentration.

FIG. 6 mesh sheeting experimental units installed in situ. The upper figure shows the buried plastic boxes with bait wood. The lower figure shows the seven experimental units in position, the left most without ant cap barrier, the second most left with ant cap barrier but without Test Wood 2, the four on the right with ant cap barrier and Test Wood 2.

FIG. 7 shows inspection of mesh sheeting experimental units inside buried boxes. (A) The buried box covered with soil. (B) The buried box uncovered to expose experimental units. (C) A plan view of the experimental units inside the buried boxes; note the many Heterotermes mud galleries on the walls of the buried box. (D) The contact to this Test Wood 2 was from a Heterotermes gallery descending from the steel lid, and not from crossing the mesh sheeting ant cap barrier.

### DESCRIPTION OF EMBODIMENTS

The present disclosure describes the following various non-limiting examples, which relate to investigations undertaken to identify alternative and improved mesh sheeting, that can provide various desirable properties such as control or repel against insects. The present inventors have surprisingly found that a treated mesh sheeting containing insecticide may control and/or repel against insects. A mesh sheeting comprising a polymeric material containing at least one insecticide in an effective amount substantially distributed throughout the polymeric material can advantageously act as a physical and chemical barrier to impede the ingress of insects into a building structure. The insect species may include, for example, termites, cockroaches, ants, spiders, fleas, flies, mosquitoes, and silverfish. In a particular example, the insect may be a termite and/or an ant.

### General Definitions and Terms

In the following description, reference is made to the accompanying drawings which form a part hereof, and which is shown, by way of illustration, several embodiments. It is understood that other embodiments may be utilised and structural changes may be made without departing from the scope of the present disclosure.

With regards to the definitions provided herein, unless stated otherwise, or implicit from context, the defined terms and phrases include the provided meanings. In addition, unless explicitly stated otherwise, or apparent from context, the terms and phrases below do not exclude the meaning that the term or phrase has acquired by a person skilled in the relevant art. The definitions are provided to aid in describing particular embodiments, and are not intended to limit the claimed invention, because the scope of the invention is limited only by the claims. Furthermore, unless otherwise required by context, singular terms shall include pluralities and plural terms shall include the singular.

All publications discussed and/or referenced herein are incorporated herein in their entirety.

Throughout this disclosure, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or groups of compositions of matter. Thus, as used herein, the singular forms “a”, “an” and “the” include plural aspects unless the context clearly dictates otherwise. For example, reference to “a” includes a single as well as two or more; reference to “an” includes a single as well as two or more; reference to “the” includes a single as well as two or more and so forth.

Those skilled in the art will appreciate that the disclosure herein is susceptible to variations and modifications other than those specifically described. It is to be understood that the disclosure includes all such variations and modifications. The disclosure also includes all of the examples, steps, features, methods, compositions, coatings, processes, and coated substrates, referred to or indicated in this specification, individually or collectively, and any and all combinations or any two or more of said steps or features.

The term “and/or”, e.g., “X and/or Y” shall be understood to mean either “X and Y” or “X or Y” and shall be taken to provide explicit support for both meanings or for either meaning.

Unless otherwise indicated, the terms “first,” “second,” etc. are used herein merely as labels, and are not intended to impose ordinal, positional, or hierarchical requirements on the items to which these terms refer. Moreover, reference to a “second” item does not require or preclude the existence of lower-numbered item (e.g., a “first” item) and/or a higher-numbered item (e.g., a “third” item).

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example and without limitation, two of item A, one of item B, and ten of item C; four of item B and seven of item C; or some other suitable combination.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

Throughout the present specification, various aspects and components of the invention can be presented in a range format. The range format is included for convenience and should not be interpreted as an inflexible limitation on the scope of the invention. Accordingly, the description of a range should be considered to have specifically disclosed all the possible sub-ranges as well as individual numerical values within that range, unless specifically indicated. For example, description of a range such as from 1 to 5 should be considered to have specifically disclosed sub-ranges such as from 1 to 3, from 1 to 4, from 1 to 5, from 2 to 4, from 2 to 5, from 3 to 5 etc., as well as individual and partial numbers within the recited range, for example, 1, 1.7, 2, 3, 3.6, 4, and 5, unless where integers are required or implicit from context. This applies regardless of the breadth of the disclosed range. Where specific values are required, these will be indicated in the specification.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Throughout this specification, the term “consisting essentially of”, or variations such as “consisting of” or “consist of, is intended to exclude elements which would materially affect the properties of the claimed composition.

The terms “comprising”, “comprise” and “comprises” herein are intended to be optionally substitutable with the terms “consisting essentially of”, “consist essentially of”, “consists essentially of”, “consisting of”, “consist of” and “consists of”, respectively, in every instance.

Herein the term “about” encompasses a 10% tolerance in any value or values connected to the term.

Herein “weight %” may be abbreviated to as “wt %”.

### Mesh Sheeting Composition and Structure

The present disclosure is directed to providing improvements in mesh sheeting for construction application. The inventors have found that a mesh sheeting containing an effective amount of an insecticide provides a treated mesh sheeting capable of controlling and/or repelling ingress of insects. The insect species may include, for example, termites, cockroaches, ants, spiders, fleas, flies, mosquitoes, and silverfish. In a particular example, the insect may be a termite and/or an ant.

In an aspect, the present disclosure provides a mesh sheeting comprising a polymeric material containing at least one insecticide in an effective amount and substantially distributed throughout the polymeric material, wherein the mesh sheeting is in the form of an open framework, wherein the mesh sheeting has a gauge between about 0.01 mm to about 1 mm and a space cloth between about 1 mm to about 8 mm, and wherein the mesh sheeting acts as a physical and chemical barrier to impede the ingress of insects into a building structure.

### Polymeric Material

The mesh sheeting may be manufactured from any suitable polymeric material. The mesh sheeting may be manufactured from at least one polymer selected from the group comprising comprising polyamide, polyvinylchloride, polyethylene, polystyrene, synthetic rubber, polymethacrylate, polypropylene, EVA polymer, fibreglass, and polyurethane. In a preferred example, the mesh sheeting may be manufactured primarily of polypropylene. In another example, the mesh sheeting may be manufactured from fibreglass.

The mesh sheeting may be woven, extruded, expanded or welded strips of the polymeric material. In some embodiments, the mesh sheeting is woven. In a preferred example, the polymeric material is fed through a loom, where it is woven into an interlocking pattern to form the mesh sheeting.

The mesh sheeting may be in the form of an open framework. Open framework is defined as the shape of the mesh. The mesh sheeting may have any suitable shape. The mesh sheeting may have a criss-cross, square, rectangular, circular, triangular framework.

It will be appreciated that the term gauge, as referred to herein, is defined as the thickness of the strands of the mesh. In other words, gauge is the measurement of the diameter of each strand used to make the mesh The mesh sheeting may have a gauge between about 0.001 mm to about 5 mm. For example, the mesh sheeting may have a gauge between about 0.01 mm to about 1 mm. The gauge may be in a range between about 0.0.1 mm to about 5 mm. For example, the gauge may be in a range between about 0.5 mm to about 2 mm. The gauge (mm) may be less than about 5, 4, 3, 2, 1.8, 1.6, 1.4, 1.2, 1, 0.5, 0.4, 0.3, 0.2, 0.1, 0.05, 0.01, 0.005, or 0.001. The gauge (mm) may be at least about 0.001, 0.05, 0.01, 0.05, 0.1, 0.2, 0.3, 0.4, 0.5, 1, 1.2, 1.4, 1.6, 1.8, 2, 3, 4, or 5. The gauge may be in a range provided by any two of these upper and/or lower values.

As used herein, space cloth is defined as the specified space between strands of the mesh. It will be appreciated that the term “space” represents the clear opening between two parallel strands. “Space cloth”, as it is commonly referred to, is measured from the inside faces of adjacent parallel strands. The mesh sheeting may have a space cloth of between about 0.1 mm to about 20 mm. For example, the mesh sheeting may have a space cloth between about 1 mm to about 8 mm. For example, the mesh sheeting may have a space cloth between about 2.5 mm and about 5 mm. The space cloth may be in a range between about 0.0.1 mm to about 5 mm. For example, the space cloth may be in a range between about 0.5 mm to about 2 mm. The space cloth (mm) may be less than about 20, 15, 10, 5, 4, 3, 2, 1.8, 1.6, 1.4, 1.2, 1, 0.5, 0.4, 0.3, 0.2, or 0.1. The space cloth (mm) may be at least about 0.1, 0.2, 0.3, 0.4, 0.5, 1, 1.2, 1.4, 1.6, 1.8, 2, 3, 4, 5, 10, 15, or 20. The space cloth may be in a range provided by any two of these upper and/or lower values.

The mesh sheeting may be of any suitable dimensions. The mesh sheeting has a width between about 100 mm and about 500 mm, preferably between about 200 mm and about 400 mm, most preferably between about 250 mm and about 300 mm. For example, the width of the mesh sheeting may be in a range between about 100 mm and about 500 mm. The width of the mesh sheeting (mm) may be less than about 500, 450, 400, 350, 300, 250, 200, 150, 100, or 50. The width of the mesh sheeting (mm) may be at least about 50, 100, 150, 200, 250, 300, 350, 400, 450, or 500. The width of the mesh sheeting may be in a range provided by any two of these upper and/or lower values.

### Adhesive Layer

The mesh sheeting may further be provided with an adhesive. In some embodiments, at least one side of the mesh sheeting has an adhesive attached thereto. In some embodiments, the adhesive may be a water resistant adhesive. In preferred embodiments, at least one side of the mesh sheeting has a water resistant adhesive attached thereto. In some embodiments, the adhesive serves to the enhance the adhesion of the mesh sheeting to a building structure. The adhesive used is only limited such that it is an adhesive suitable for use in adhesively bonding the mesh sheeting to surfaces to provide a termite impervious connection therebetween. It is desirable for the adhesive to have at least one of the following properties: durability, resistance to environmental damage, be fast drying, oil resistant, water resistant, and heat resistant. Suitable adhesives may include, but are not limited to mortar, epoxy, acrylic, and polyvinyl acetate based adhesives. In some embodiments, the adhesive is an epoxy adhesive.

### Removable Cover

Where the mesh sheeting is further provided with an adhesive, the mesh sheeting may further comprise a removable cover releasably attached to the adhesive whereby the removable cover is adapted to be removed upon application to a building structure. In some embodiments, the removable cover serves to protect and/or preserve the adhesiveness of the adhesive prior to application to a building structure. The removable cover may be made of any suitable material.

### Insecticide

The present inventors have surprisingly found that the addition of an insecticide to the mesh sheeting is capable of controlling and/or repelling insects. For example, the insecticide exhibits control or repellent affects against insects when provided in an effective amount and substantially distributed throughout the polymeric material. The insect species may include, for example, termites, cockroaches, ants, spiders, fleas, flies, mosquitoes, and silverfish. In a particular example, the insect may be a termite and/or an ant.

The insecticide may be extruded with the polymeric material. The process of manufacturing mesh sheeting including the insecticide may comprise (i) mixing raw materials including the polymeric material (i.e. in the form of pellets), an insecticide, and optionally one or more additives, as described herein; (ii) extruding the mixture of raw materials into a polymeric yarn; (iii) the polymeric yarn may be heated in the presence of an optional filler (e.g. CaCO₃) and an optional pigment to form a polymeric yarn mixture, (iv) and the polymeric yarn mixture melted and extruded into a film.

The insecticide may be any active agent that exhibits control or repellent affects against insect species.

The insecticide may also be non-repellents such as the neonicotinoid (e.g. imidacloprid), phenylpyrazole (e.g fipronil), and naturally occurring substances, such as those found in termite resistant trees, such as those found in Red Gum trees, Eucalyptus camaldulensis.

The insecticide(s) may be any active agent that exhibits control or repellent affects against insect species. The active agent(s) may include, but are not limited to, pyrethrum, synthetic pyrethroids, organochlorines, organosulfurs, carbamates, organophosphates, formamidines, neonicotinoids, nicotinoids, spinosyns, phenylpyrazoles, pyrroles, pyrazoles, dinitrophenols, pyridazinones, quinazolines, and benzoylureas. Preferably, a noted termiticide is used such as bifenthrin, permethrin, deltamethrin, lambda-cyhalothrin, cypermethrin, alpha-cypermethrin, zeta-cypermethrin, tetramethrin, and cyfluthrin.

The term “pyrethrum” as used herein means pyrethrin compounds derived from chrysanthemum plants, or the same or similar compounds derived from other natural sources, and pyrethroid compounds manufactured synthetically. Specific examples of such compounds include, but are not limited to, deltamethrin, permethrin, cypermethrin, bifenthrin, cyfluthrin, cyhalothrin, tefluthrin, resmethrin, allethrin, kadethrin, sanmarton, fenvalerate, esfenvalerate, lambda-cyhalothrin, tralomethrin, fenpropathrin, tetramethrin, as well as mixtures thereof. These compounds may be extracted from plant sources or may be prepared by a suitable chemical process, and are commercially available from such sources as AgrEvo, Zeneca, Bayer, FMC Corporation, and Aldrich Chemical. Preferably, the compound is a pyrethroid compound selected from deltamethrin, permethrin, bifenthrin, and mixtures thereof. In a particular embodiment, the insecticide bifenthrin is used. Bifenthrin has a non-alpha-cyano molecular structure which renders it a dermal non-sensitiser, i.e. does not react substantially with a person's skin.

The pyrethrum and synthetic pyrethroid family of compounds have very effective surface contact insect repellence, which is important to the prevention of insect attack to any mesh sheeting products which contains them. The thermal and chemical stability and structure of pyrethrum and synthetic pyrethroid compounds adds to their suitability in plastic manufacturing processes. After manufacture, many pyrethrum and synthetic pyrethroid compounds remain encapsulated in the polymeric plastic resin because of their chemical structure and relatively low vapour pressure. As a result, the pyrethrum and synthetic pyrethroid compounds provide long-term protection against insect borings that could affect the physical properties of the mesh sheeting. The concentration of pyrethrum and synthetic pyrethroid compounds in the polymeric material that provides the desired efficacy depends on the specific material used and the targeted insect.

In an embodiment, the insecticide is selected from any one or more of the group comprising pyrethrum, synthetic pyrethroids, organo-chlorines, organo-sulfurs, carbamates, organo-phosphates, formamidines, neonicotinoids, nicotinoids, spinosyns, phenylpyrazoles, pyrroles, pyrazoles, dinitrophenols, pyridazinones, quinazolines, and benzoylureas.

In an embodiment, the insecticide may be a synthetic pyrethroid compound selected from the group comprising deltamethrin, permethrin, bifenthrin, and mixtures thereof. The at least one insecticide may be a termiticide. For example, the insecticide is bifenthrin.

In an embodiment, the concentration of insecticide may be between about 0.2 wt. % and about 4.0 wt. %. In an embodiment, the concentration of insecticide may be between about 0.01 wt. % and about 4.0 wt. %. The concentration of insecticide may be between about 0.5 wt. % and about 2.0 wt. %. The concentration of insecticide may be less than about 4, 3.5, 3, 2.5, 2, 1.5, 1, 0.9, 0.8, 0.7, 0.6, 0.5, 0.4, 0.3, 0.2, 0.1, 0.09, 0.08, 0.07, 0.06, 0.05, 0.04, 0.03, 0.02, or 0.01. The concentration of insecticide may be at least about 0.01, 0.02, 0.03, 0.04, 0.05, 0.06, 0.07, 0.08, 0.09, 0.1, 0.2, 0.3, 0.4, 0.5, 0.6, 0.7, 0.8, 09, 1, 1.5, 2, 2.5, 3, 3.5, or 4. The concentration of insecticide may be in a range provided by any two of these upper and/or lower values.

### Optional Additives

The mesh sheeting may further comprise a fibre. The fibre may be selected from the group comprising glass (in fibreglass), carbon (in carbon-fibre-reinforced polymer), aromatic polyamide (aramid), or basalt. For example, the fibre is fibreglass.

The mesh sheeting may further comprise one or more additives selected from the group comprising inorganic fillers, pigments, stabilizers, antioxidants, antifungal agents, acid scavengers, ultraviolet absorbers, flame retardants, processing aids, dispersion aids, extrusion aids, and the like.

A stabilizing agent may be present in the mesh sheeting. The stabilizing agent may be selected from any one or more of inorganic silicate, silicone dioxide, hydrophobic silicone dioxide, montmorillonite clay, sodium bentonite clay with high montmorillonite content, kaolin, kaolinite, magnesium aluminium silicate and aluminium silicate. The stabilizing agent may be a high surface area inorganic silicate, preferably a high surface area aluminium silicate. For example, stabilizing agent may be kaolin.

In an embodiment, a stabilizing agent may be present in the mesh sheeting in an amount of between about 0.1 wt. %. and about 10 wt. %. The stabilizing agent may be in an amount (wt. %) of less than about 10, 8, 6, 4, 2, 1, 0.5, or 0.1. The stabilizing agent may be in an amount (wt. %) of at least about 0.1, 0.5, 1, 2, 4, 6, 8, or 10. The stabilizing agent may be in a range provided by any two of these upper and/or lower values.

The mesh sheeting may also contain a UV stabilizer/UV absorbers to prevent break down of the mesh sheeting when exposed to sunlight. This is important in maintaining the longevity of the mesh sheeting which may be in place for extended periods of time.

Pigment may be added to the polymeric material prior to forming the mesh sheeting to give the mesh sheeting a specific colour. In an embodiment, the polymeric material may be a black, grey, blue, brown, green, yellow, silver, orange, red, or natural colour. In a particular example, the polymeric material may be green. This is an important feature of the invention as it will provide a visual aid to workers to distinguish mesh sheeting which contain an insecticide.

### Use of the Termite Perimeter System

There is also provided a termite perimeter system comprising application of the mesh sheeting as described herein to a building structure, wherein the mesh sheeting acts as a physical and chemical barrier to impede the ingress of insects into the structure. In some embodiments the mesh sheeting may be integrally attached to part of the building structure by an adhesive or attachment means providing a bond between at least a portion of the mesh sheeting and part of the building structure.

The mesh sheeting may be applied to, but are not limited to, fiberglass reinforced polyester, polystyrene, wood, timber, cork, varnished surfaces, metals, glass, cardboard, leather, concrete, ceramic tiles, brickwork, and steel.

There is also provided a method of installing a mesh sheeting in a building structure, the method comprising:
i) providing a mesh sheeting comprising a polymeric material containing at least one insecticide in an effective amount and substantially distributed throughout the polymeric material according to any one of embodiments described herein;
ii) contacting a first portion of the mesh sheeting to a first part of the building structure; and
iii) contacting a second portion of the mesh sheeting to a second part of the building structure,
wherein, after installation, the mesh sheeting is configured to impede ingress of insects into the building structure between the first part and the second part of the building structure.

In embodiments, the mesh sheeting may be integrally attached to the building structure by an adhesive or attachment means providing a bond between the first portion of the mesh sheeting and the first part of the building structure and/or the second portion of the mesh sheeting and the second part of the building structure.

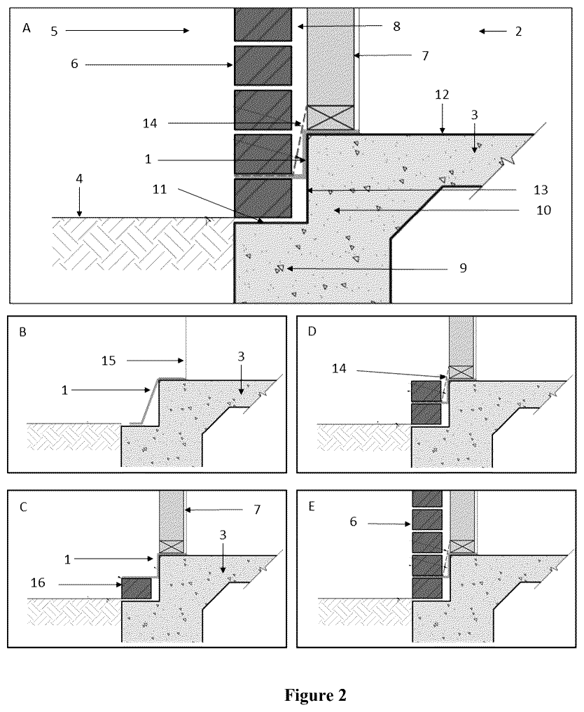

Referring now to FIG. 2, shown in FIG. 2A is exemplified the installed mesh sheeting. The mesh sheeting 1 is attached to a building structure 2. The building structure 2 comprises a concrete slab 3 at or near ground level 4. The concrete slab 3 supports a wall construction 5 comprising an external wall 6 and an internal wall 7 with a wall cavity 8 therebetween. The slab 3 incorporates an integral footing 9 and a rebate 10 to provide a footing 11 for the external wall 6. The internal wall 7 is supported on the upper face 12 of the slab 3 immediately adjacent the rebate 10. The rebate 10 presents a side face 13 which confronts the cavity 8. In the arrangement shown, the external wall 6 is constructed of brick. The external wall may be assembled in a manner known to the person skilled in the art. The internal wall 7 is of framed construction, particularly of framed timber construction, and may be assembled in a manner known to the person skilled in the art.

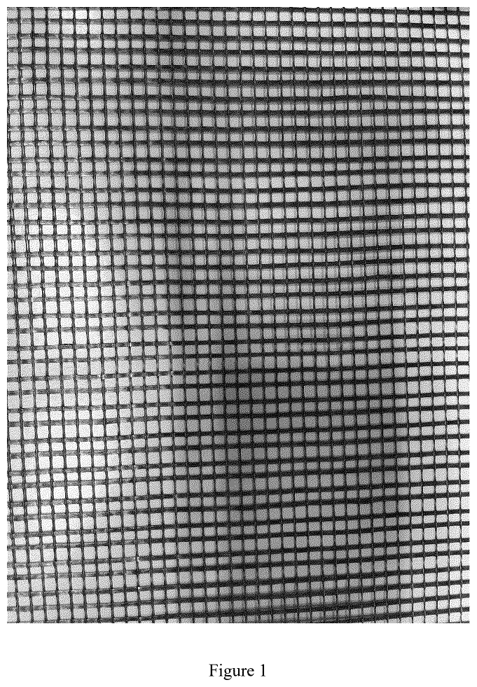

The method for installation of the mesh sheeting is shown sequentially in FIG. 2B to 1E. FIG. 2B shows Stage 1 of the installation method. The mesh sheeting 1 is installed horizontally on the slab 3 after chalk lines 15 (vertical line indicates chalking position on slab) have been flicked for installation of timber frames 7. Adhesion of the mesh sheeting 1 to the slab 3 may be enhanced by the inclusion of an adhesive, as described herein, on the slab facing side of the mesh sheeting.

FIG. 2C shows Stage 2 of the installation method. Perimeter bricks 16 are laid to the proposed weep hole height (not shown). The mesh sheeting 1 is set to within 2-3 mm of the edge to allow for bricks to be pointed. A spray adhesive (not shown) may be applied to the bricks to secure the mesh sheeting thereto. At this point the timber frame (internal wall 7) may be installed on top of the mesh sheeting. Adhesion of the mesh sheeting to the timber frame may be enhanced by the inclusion of an adhesive, as described herein, on the frame facing side of the mesh sheeting.

FIG. 2D shows Stage 3 of the installation method. Damp proof flashing 14 may be installed horizontally on top of the mesh sheeting and secured vertically at a desired height to the timber frame.

FIG. 2E shows Stage 4 of the installation method. Additional courses of bricks are laid to complete the external wall 6.

### EXAMPLES

The present disclosure will now be described with reference to the following non-limiting examples and with reference to the accompanying Figures.

### Example 1: Field Trial of Mesh Sheeting

The aim of the aim of the field trial can be to evaluate the effectiveness of mesh sheeting, as described herein, as a barrier against subterranean termites compared to a control.

The mesh sheeting comprises either one of two active ingredients (AIs), bifenthrin and deltamethrin, both of which are synthetic pyrethroids. Both AIs have the capacity to repel and kill termites.

The mesh sheeting is to be provided with different concentrations of each AIs. For bifenthrin, the mesh sheeting is to be provided with bifenthrin concentrations 0.02, 0.04 and 0.2 wt %, and these sheets are to be referred to as B0.02, B0.04 and B0.2 respectively. For deltamethrin, the mesh sheeting is to be provided with deltamethrin concentrations 0.1, 0.04 and 0.01%, and these sheets are to be referred to as D0.01, D0.04 and D0.1 respectively. A control mesh sheeting containing no active ingredient was also provided.

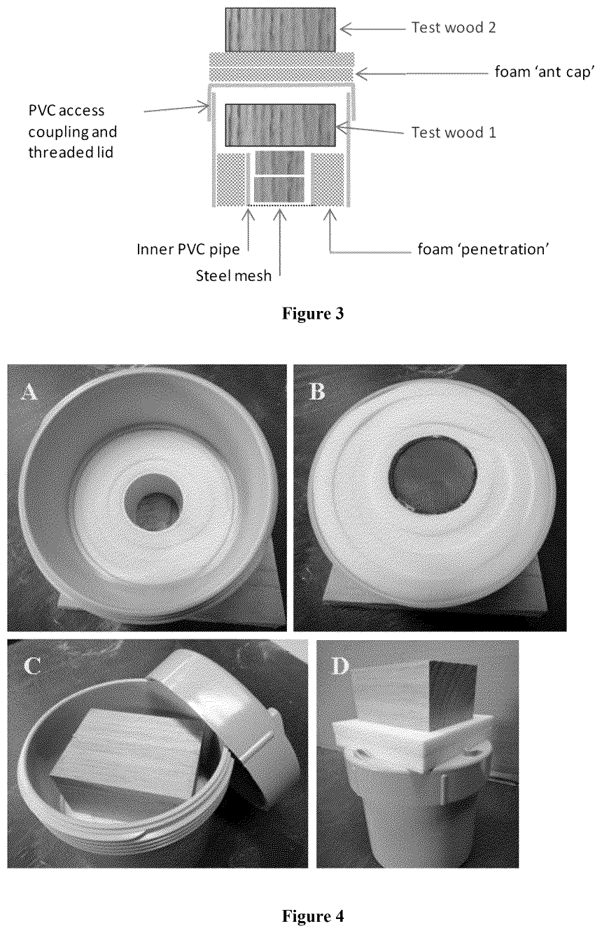

Experimental units are to be made from mesh sheeting (the material under test), as described herein, unplasticised PVC pipe, stainless steel mesh and wood. The main body of each experimental unit is to be made from a PVC threaded access coupling, plus the threaded lid (110 mm internal×110 mm long) (FIG. 3 and FIG. 4). The pipe is to stand vertically, with the threaded end and lid uppermost. The bottom of the access coupling is to enclose a section of small diameter pipe (43 mm outer×50 mm long). The base of the inner pipe is to be covered with fine aperture stainless steel mesh (0.45 mm² apertures, which are too small for termites to pass through).

The mesh sheeting penetration barrier is to be placed between the small ‘inner’ pipe and the large access coupling. A strip of mesh sheeting (0.1 mm thick×0.2 mm high×150 mm long) is to be wrapped tightly around the inner pipe, held in place by double sided tape, and then inserted into the bottom half of the access coupling (FIGS. 2 and 3). The mesh sheeting wrapping is to be slightly larger in diameter than the inner diameter of the access coupling, thus it may be compressed slightly during insertion, consequently the mesh held itself in position.

A piece of test wood (the highly palatable species Pinus radiata, 45 mm×90 mm dressed, cut to 90 mm lengths) is to be placed inside the experimental unit (hence Test Wood 1). Two smaller blocks of wood (20×20×30 mm) are to be placed in the inner PVC pipe and against the stainless steel mesh. The termites detect the test wood inside the unit through the stainless steel mesh. As the stainless steel mesh and PVC pipe are termite resistant, the termites must chew through and penetrate the mesh sheeting in order to access the test wood.

TABLE 1
Ranking of termite attack on mesh sheeting.

| Ranking | Description |
|---|---|
| No contact | No evidence of termites having been in contact (e.g. |
| | faecal spotting or gallery construction). |
| Intact | Evidence of termite contact with the mesh sheeting but |
| | termites did not penetrate through the mesh sheeting. Test |
| | Wood 1 remained intact. |
| Penetrated and destroyed | Termites penetrated through mesh sheeting, and Test |
| | Wood 1 attacked. |

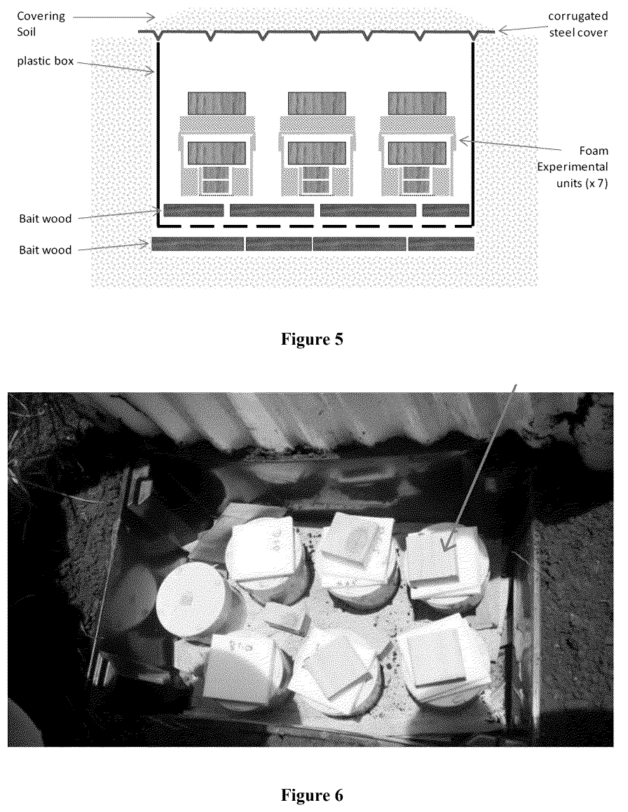

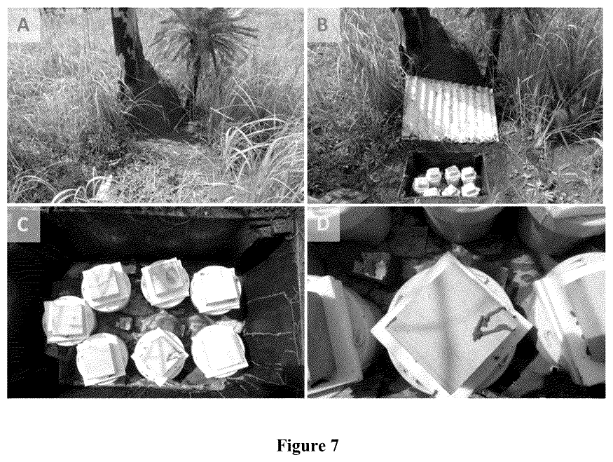

20 replicates of each of the seven (B0.02, B0.04, B0.2, D0.01, D0.04, D0.1 and control) experimental units are to be manufactured. One replicate of each experimental unit is to be included in an experimental set for field installation (FIG. 5 and FIG. 6). Each group is to be placed in buried plastic boxes (640×450×260 mm deep). The plastic boxes are to allow for mimicked conditions under houses, and for simple inspections. The bases of the boxes are to be holed (˜12 mm holes, 24 times) and buried, top flush with the soil surface, therefore the base of the box was approximately 300 mm deep. Termite activity is highest between 150-400 mm depth, depending on latitude, soil type, season and weather, therefore burying units at this depth is to maximise their exposure to termites. The holes in the boxes are to allow easy termite access. The trenches into which the plastic boxes are to be placed, and the boxes themselves, are to be lined with bait wood to encourage termite exploration and infestation (FIG. 6).

10 of the sets are to be installed at field sites adjacent to C. acinaciformis mounds, separated over 1.5 km, to ensure different colonies. 10 of the groups are to be installed at field sites M. darwiniensis foraging sites, separated over 1.5 km, to ensure different colonies. Each set of experimental units are to be placed in plastic boxes (FIG. 5) in 300 mm deep trenches lined with P. radiata boards and veneers as bait wood to attract the termites to the experimental units. The plastic boxes are to be covered with corrugated steel roofing (1000×600 mm), and a layer of soil (FIG. 5 and FIG. 6).

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A mesh sheeting comprising a polymeric material containing at least one insecticide in an effective amount and substantially distributed throughout the polymeric material, wherein the mesh sheeting is in the form of an open framework, wherein the mesh sheeting has a gauge between about 0.01 mm to about 1 mm and a space cloth between about 1 mm to about 8 mm, and wherein the mesh sheeting acts as a physical and chemical barrier to impede the ingress of insects into a building structure.

2. The mesh sheeting of claim 1, wherein the polymeric material is manufactured from at least one polymer selected from the group comprising polyamide, polyvinylchloride, polyethylene, polystyrene, synthetic rubber, polymethacrylate, polypropylene, EVA polymer, fibreglass, and polyurethane.

3. The mesh sheeting of claim 1, wherein the polymeric material further comprises a fibre,
wherein the fibre may be selected from the group comprising glass (in fibreglass), carbon (in carbon-fibre-reinforced polymer), aromatic polyamide (aramid), or basalt.

4. The mesh sheeting of claim 1, wherein the mesh sheeting is woven, extruded, expanded or welded strips of the polymeric material.

5. The mesh sheeting of claim 1, wherein the mesh sheeting has a space cloth between about 2.5 mm and about 5 mm and a width between about 100 mm and about 500 mm.

6. The mesh sheeting of claim 1, wherein at least one side of the mesh sheeting has a water resistant adhesive attached thereto.

7. The mesh sheeting of claim 1, wherein the mesh sheeting further comprises a removable cover releasably attached to a water resistant adhesive whereby the removable cover is adapted to be removed upon application to a building structure.

8. The mesh sheeting of claim 1, wherein the insecticide exhibits control or repellent affects against insects.

9. The mesh sheeting of claim 1, wherein the insecticide is extruded with the polymeric material or composite material.

10. The mesh sheeting of claim 1, wherein the insecticide is selected from any one or more of the group comprising pyrethrum, synthetic pyrethroids, organo-chlorines, organo-sulfurs, carbamates, organo-phosphates, formamidines, neonicotinoids, nicotinoids, spinosyns, phenylpyrazoles, pyrroles, pyrazoles, dinitrophenols, pyridazinones, quinazolines, and benzoylureas.

11. The mesh sheeting of claim 1, wherein the insecticide is a synthetic pyrethroid compound selected from the group comprising deltamethrin, permethrin, bifenthrin, and mixtures thereof.

12. The mesh sheeting of claim 1, wherein the insecticide is bifenthrin.

13. The mesh sheeting of claim 1, wherein the concentration of the insecticide is between about 0.2 wt. %, and about 4.0 wt. %, preferably between about 0.5 wt. % and about 2.0 wt. %.

14. The mesh sheeting of claim 1, wherein a stabilizer is present in the polymeric material or composite material in an amount between 0.1 wt. % and about 10 wt. % and the stabilizer is selected from the group comprising inorganic silicate, silicone dioxide, hydrophobic silicone dioxide, montmorillonite clay, sodium bentonite clay with high montmorillonite content, magnesium aluminium silicate and aluminium silicate.

15. The mesh sheeting of claim 1, wherein the polymeric material or composite material further comprises one more additives selected from the group comprising inorganic fillers, pigments, lubricants, stabilizers, antioxidants, antifungal agents, acid scavengers, ultraviolet absorbers, flame retardants, processing aids, dispersion aids, extrusion aids, and the like.

16. The mesh sheeting of claim 1, wherein the polymeric material or composite material comprises a stabilizer and the stabilizer is kaolin.

17. The mesh sheeting of claim 1, wherein the polymeric material or composite material includes a UV stabilizer.

18. A termite perimeter system comprising application of the mesh sheeting according to claim 1 to a building structure, wherein the mesh sheeting acts as a physical and chemical barrier to impede the ingress of insects into the structure.

19. The termite perimeter system of claim 18, wherein the mesh sheeting is integrally attached to part of the building structure by an adhesive or attachment means providing a bond between at least a portion of the mesh sheeting and part of the building structure.

20. A method of installing a mesh sheeting in a building structure, the method comprising:
i) providing a mesh sheeting comprising a polymeric material containing at least one insecticide in an effective amount and substantially distributed throughout the polymeric material according to claim 1;
ii) contacting a first portion of the mesh sheeting to a first part of the building structure; and
iii) contacting a second portion of the mesh sheeting to a second part of the building structure,
wherein, after installation, the mesh sheeting is configured to impede ingress of insects into the building structure between the first part and the second part of the building structure.

21. The method of claim 20, wherein the mesh sheeting is integrally attached to the building structure by an adhesive or attachment means providing a bond between the first portion of the mesh sheeting and the first part of the building structure and/or the second portion of the mesh sheeting and the second part of the building structure.
